(19) United States
(12) Patent Application Publication
(10) Pub. No.: US 2010/0005102 A1
(43) Pub. Date: Jan. 7, 2010

(54) METHOD AND APPARATUS FOR MANAGING DOCUMENT/MESSAGE CONTENT FOR DISTRIBUTION TO SUBSCRIBERS

(75) Inventor: Rolf R. STEFANI, West River, MD (US)

Correspondence Address: PRASS LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 12/559,782

(22) Filed: Sep. 15, 2009

Related U.S. Application Data
(63) Continuation-in-part of application No. 11/755,350, filed on May 30, 2007.
Application No. 11/755,350 is a continuation-in-part of application No. 11/770,060, filed on Jun. 28, 2007.
(60) Provisional application No. 61/183,128, filed on Jun. 2, 2009.
(60) Provisional application No. 60/896,484, filed on Mar. 22, 2007.
(60) Provisional application No. 60/896,484, filed on Mar. 22, 2007.

(51) Int. Cl. G06F 17/30; G06F 15/16

(52) U.S. Cl. 707/10; 709/217; 707/E17.001

(57) ABSTRACT

A method for managing the document/message content for distribution to subscribers is disclosed. The method may include receiving documents/messages from sources, downloading the documents/messages to intended subscribers' remote devices, uploading any documents/messages from subscribers remote devices' that have been identified for uploading, and downloading the uploaded documents/messages to intended subscribers' remote devices.

### PRIORITY INFORMATION

This non-provisional application claims priority from 1) U.S. Provisional Application Ser. No. 61/183,128, filed, Jun. 2, 2009, and 2) is a Continuation-in-Part of U.S. Non-Provisional application Ser. Nos. 11/755,350, filed May 30, 2007 and 11/770,060, filed Jun. 28, 2007, both of which claim priority from U.S. Provisional Application Ser. No. 60/896,484, filed Mar. 22, 2007. The content of application Nos. 61/183,128, 11/755,350, 11/770,060 and 60/896,484 from which priority is claimed are all incorporated herein by reference in their entireties.

### BACKGROUND OF THE DISCLOSED EMBODIMENTS

1. Field of the Disclosed Embodiments

The disclosed embodiments relates to document/message content management and distribution to subscribers.

2. Introduction

In response to the increasing desire to become more environmentally conscious and cost effective, and along with the proliferation of portable electronic devices such as PDA's laptop and tablet computers, Netbooks, and eReader devices, more and more documents are being published digitally and are used in their digital form on the above mentioned devices. This process eliminates the need to consume paper which in turn, reduces cost and waste of environmental resources.

However, while digital publishing technology has matured and portable devices now have sufficient battery life and displays that have resolutions necessary to view electronic documents acceptably, the mechanism of delivering documents easily to enterprise-wide user groups has not yet been developed in a manner that is sufficiently reliable and user friendly to automatically and seamlessly manage content on large numbers of devices. While there are conventional systems that provide content delivery to some extent, none are easy to use or sufficiently reliable from either the administrators or the user's perspective. For example, such systems may require users to receive e-mails advising them of new content and require them to log onto specific web sites and manually download documents or save attachments on their devices. These systems typically require significant user interaction and do not manage the document storage on their devices.

### SUMMARY OF THE DISCLOSURE

A method for managing the document/message content for distribution to subscribers is disclosed. The method may include configuring one or more subscriber profiles with subscriber's personal and remote device information, storing the one or more subscriber profiles in a subscriber database, receiving one or more document/messages from one or more document/message sources, determining which of the one or more subscribers are to receive each of the received one or more document/messages, storing an indicator for each of the received document/messages in a download pending file in each subscriber profile for each subscriber that has been determined to receive the one or more document/messages, receiving a sync request from a remote device, retrieving the subscriber's profile corresponding to the remote device, downloading any documents/messages from the subscriber's download pending file, uploading any documents/messages from the subscriber's remote device that have been identified for uploading, determining which of the one or more subscribers are to receive each of the uploaded one or more document/messages, storing an indicator for each of the uploaded document/messages in the download pending file in each subscriber profile for each subscriber that has been determined to receive the one or more uploaded document/messages, and downloading the uploaded documents/messages to each subscriber's device that has been determined to receive the one or more uploaded document/messages upon receiving a sync request from each subscriber.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is diagram of an exemplary content management environment in accordance with a possible embodiment of the disclosure;

FIG. 2 is a block diagram of an exemplary content management system in accordance with a possible embodiment of the disclosure;

FIG. 3 is an exemplary flowchart illustrating one possible content management process in accordance with one possible embodiment of the disclosure;

FIG. 4 is a screenshot of an exemplary master document/message content management interface in accordance with a possible embodiment of the disclosure;

FIG. 5 is a screenshot of an exemplary list of document/message content to be posted to a particular remote device in accordance with a possible embodiment of the disclosure;

FIG. 6 is a screenshot of an exemplary message creation interface in accordance with a possible embodiment of the disclosure;

FIG. 7 is a screenshot of an exemplary interface to forward documents/messages to subscribers in accordance with a possible embodiment of the disclosure; and

FIG. 8 is a screenshot of an exemplary interface to set the lifespan of a document in accordance with a possible embodiment of the disclosure.

### DESCRIPTION OF THE DISCLOSED EMBODIMENTS

Additional features and advantages of the disclosed embodiments will be set forth in the description which follows, and in part will be obvious from the description, or may be learned by practice of the disclosed embodiments. The features and advantages of the disclosed embodiments may be realized and obtained by means of the instruments and combinations particularly pointed out in the appended claims. These and other features of the present disclosed embodiments will become more fully apparent from the following description and appended claims, or may be learned by the practice of the disclosed embodiments as set forth herein.

Various embodiments of the disclosed embodiments are discussed in detail below. While specific implementations are discussed, it should be understood that this is done for illustration purposes only. A person skilled in the relevant art will recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments. Note that while this disclosure discusses aircraft and airline uses for the disclosed embodiments, the disclosed embodiments by no means are limited to that technology area and may be applied to a wide variety of environments and uses.

The disclosed content management system may be intended for a specific type of user community that may use their device and documents in a very structured and specific way. The users may have no need or desire to actively participate in publishing or managing documents on their devices.

In this manner, the disclosed embodiments may permit role and device specific content delivery to be a simple, managed activity and provide users of electronic devices with current up-to-date content on their device. The disclosed embodiments may concern a Web-based server/client Integrated software system/application and communications capabilities that provide for simplified and hierarchal described user role specific management, delivery, and verification of digital documents to a plurality of portable and/or fixed computing devices including desktop and laptop and other portable computers, to electronic paper (epaper) based document reader devices and other communications enabled display capable devices such as PDA's, UMPC's (ultra mobile PC) and Netbooks.

The disclosed embodiments may comprise a system of integrated software components and necessary physical or wireless communications media necessary to manage content of electronic devices. A simple to use content management system described in the disclosed embodiments may ensure timely and accurate delivery of electronic documents, files and information to all appropriate electronic devices that have subscriptions or have been designated to require specific documents, files or other data items to reside on their inherent data storage mechanisms for quick and reliable access.

As one example, the content management system and method may be useful in an environment were numerous electronic reading (eReader) devices have been assigned or deployed to a specific user community, such as to aircraft flight crews, and users could be defined as pilots, co-pilots, flight engineers and loadmasters all for a specific type of airframe (e.g., 737-300). The devices the crew may be intended for structured content viewing for things like operations manuals and other airframe and operational information specific documents.

When the device is used, there may be a menu of documents that allows the user to select and view any of the specific manuals on the device. So if a new manual was published by the flight crew headquarters or administrators, the content may be distributed to all devices that require the specific document. The document administrator may also select that the document is only required to be sent to pilots of 737-300 and other users in that community would not require downloading of that specific document or have access or ever be aware of these specific documents, for example.

When a user presses the “sync” button on his or her device, the device may connect to a content server, automatically identify the device and download any waiting documents without any additional user interaction except to report the status of the process to the user on his or her device display. When the transaction is completed, the administration application may archive the document and the transaction details for future reporting purposes. In the above example, the user pilot may be assured that by the simple invocation of the “sync” feature, the device is updated appropriately and that the documents are current and updated.

The content management system may also work in both directions. Should a pilot have entered data on his device, such as a note or a signature on a document, when the “sync” feature is selected, any documents selected for delivery to the content management system may be placed in his device “outbox” (waiting for delivery) and may be uploaded to the content management system and be distributed according to administrator rules previously set up on the system. These rules may contain instructions such as to e-mail the document to a specific address or simply to notify the administrator and archive the document for future retrieval, for example.

The new system may be implemented and described as at least three components. The components may include a server-based application, an administration application, and a user device application, that may work together to provide a seamless, automated system.

The Administrator application may allow document administrators to easily and quickly:
Remotely access a common server (preferably with redundant data storage architecture to ensure recovery of data due to failure) in order to manage associated databases which may include user and device relationships, user to sub group (subscriber group) relationships, document libraries, and associations between library documents and appropriate users or user groups.
Operate in a stand-alone mode (no remote server required) to manage a local subset or the entire group of user devices with all databases located on their local computer and storage system, such as an administrator's computer system.
Post or publish new or existing documents to the system for automatic distribution and delivery to appropriate devices autonomously when they are either physically connected or connected by a communications mechanism such as 802.11, Cellular data connection or Bluetooth technology.
To receive documents or computer files from user devices and store and archive them on the local computer and storage system and forward them to a redundant server.

The client device application may provide the capabilities to:
Allow users to simply initiate the capability to log onto the server system (communications permitting).
Automatically send pending local files and documents to the server system.
Automatically receive files and documents from the server system and store them in the appropriate locations on a local storage media on the device.
Provide appropriate status and feedback to the user that may initiate synchronization activity.

The content management system and data archive system may be the central component that maintains system wide databases and access for administrators and users and may be the overarching management component of the system. The content management system and data archive system may ensure that:
Administrators may post or publish files and documents to devices, users and user groups.
Administrators may configure new users, groups and devices with access to appropriate files and documents, their specific subscriptions.
All data may be archived and audit trails are managed and saved.
Users may upload and download appropriate files and documents as appropriate.
Users may restore device content should they change devices.

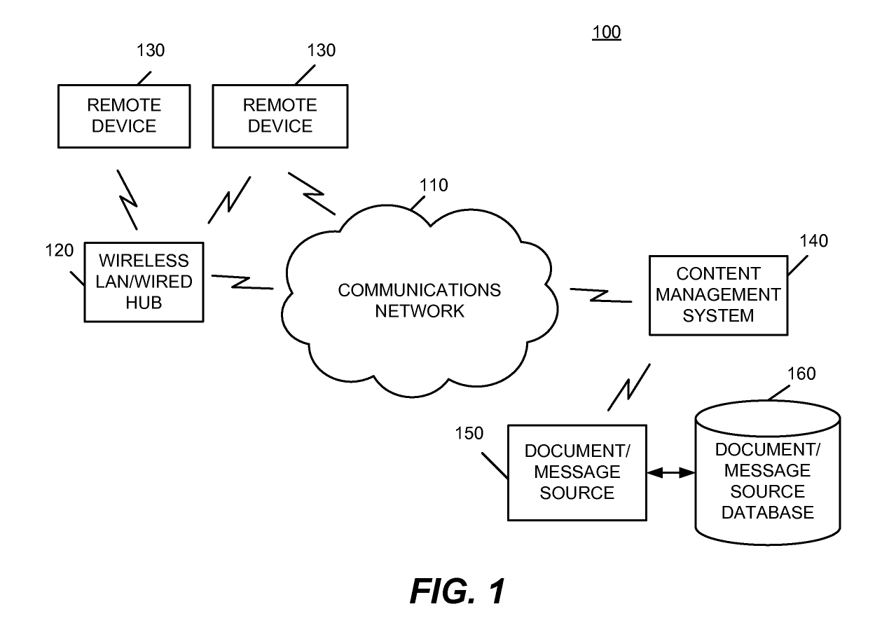

FIG. 1 is diagram of an exemplary content management environment 100 in accordance with a possible embodiment of the disclosure. The content management environment 100 may include wired local area network (LAN)/wired hub 120 and content management system 140 connected to the communications network 110.

Wireless land/wired hub 120 may be connected to one or more remote devices 130. The content management system 140 may be connected to one or more document/message sources 150 which may then be connected to one or more document/message source databases 160. Although the connections in FIG. 1 are shown as a wireless configuration, one or more of these connections may also be wired.

Communications network 110 may represent any communications network used to communicate with other entities, including the Internet, an intranet, a radio network, a wireless network, etc. Wireless land/wired hub 120 may represent any land, hub, router, switch, server, computer, or any other device that may serve as an intermediate communication routing device between the communications network 110 and the remote devices 130.

The content management system 140 may be any server, computer, processing device, personal digital assistant PDA), or other similar device capable of storing and managing media publications and other documents and products. The one or more remote devices 130 may represent any device that is capable of receiving and displaying (or playing) documents and messages, such as an e-paper device, an e-reader device, a PDA, wireless telephone phone, computer, server, processing device, display, or MP3 player.

The content management system 140 may be able to receive emails from sources that have been authorized (e.g., via a database or approved source list). The content management system 140 may accept emails and check the source and destination. For example, the content management system 140 may be configured to allow emails from “@ARINC.COM” and archive and store the attachments so that they could be delivered to the subscriber/user. Thus, if a subscriber is authorized to email content, the subscriber may be able to send a document to an email address like B737-300@arinccontentmanager.net and the attachment may be stored and put in a queue or file for any user or user group, such as 737-300, for example, and later be delivered to the intended subscribers.

A list of documents in which subscribers may be interested may be created on the content management system 140. The list that may be delivered to subscribers and once it is received, a subscriber may indicate (via check boxes, etc.) that he or she has an interest in subscribing to selected documents and would receive them in the future when new content was available. Note that when the subscriber selects the content for future delivery, the form he or she generates may be delivered back to the content management system 140 on next sync. A person may be able to un-subscribing to a list, as well.

The content management system 140 may also be configured to flag or indicate that a document requires confirmation from the subscriber when he or she has read it. This process may be performed by returning an electronic acknowledgement which could in fact be a digital signature, for example. The returned acknowledgement may be archived and stored, as appropriate.

The one or more document/message sources 150 may represent any document/message source, including any commercial or private source that may wish to distribute documents/messages to one or more subscribers. The one or more document/message source databases 160 may serve to store messages, video, audio, and up-to-date media publications, including books, magazines, newspapers, etc. for the document/message source 150 to upload to the content management system 140. In one possible embodiment, the document/message source content may be aviation-related, for example. However, the document/message content for the disclosed embodiments is not limited to a particular area and may be any possible documents/messages known to one of skill in the art.

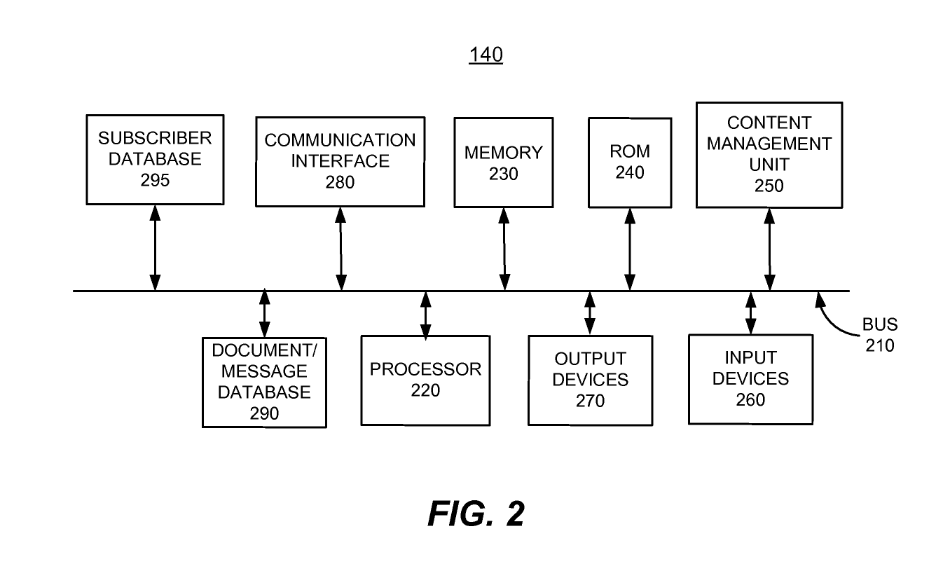

FIG. 2 is a block diagram of an exemplary content management system 140 in accordance with a possible embodiment of the disclosure. The exemplary content management system 140 may include bus 210, processor 220, memory 230, read only memory (ROM) 240, content management unit 250, input devices 260, output devices 270, communication interface 280, document/message database 290, and subscriber database 295. Bus 210 may permit communication among the components of the content management system 140.

Processor 220 may include at least one conventional processor or microprocessor that interprets and executes instructions. Memory 230 may be a random access memory or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any storage device that may include any type of media, such as, for example, magnetic or optical recording media and its corresponding drive.

Input devices 260 may include one or more conventional mechanisms that permit a user to input information to the content management system 140, such as a keyboard, a mouse, a pen, a voice recognition device, etc. Output devices 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the content management system 140 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the content management system 140, communication interface 280 may not be included in the exemplary content management system 140 when the content management process is implemented completely within the content management system 140.

The document/message database 290 may serve to store messages, video, audio, and up-to-date media publications, including books, magazines, newspapers, etc. received from the document/message source 150 or another subscriber's remote device 130, for example. In one possible embodiment, the document/message content may be aviation-related, for example. However, the document/message content is not limited to a particular area and may be any possible documents/messages known to one of skill in the art.

The subscriber database 295 may contain subscriber profiles relating to each subscriber for the content management system 140. The subscriber profiles may contain subscriber information, such as subscriber identification information, subscriber remote device 130 identification information, and a download pending file that may include indicators (or links) to documents that are to be downloaded to the subscriber's remote device. Note that both or either of the document/message database 290 and the subscriber database 295 may be stored in the memory 230, for example.

The content management system 140 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device, or from a separate device via communication interface 280.

The content management environment 100 and the content management system 140 illustrated in FIGS. 1 and 2 and the related discussion are intended to provide a brief, general description of a suitable computing environment in which the disclosure may be implemented. Although not required, the disclosure will be described, at least in part, in the general context of computer-executable instructions, such as program modules, being executed by the content management system 140, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

For illustrative purposes, the operation of the content management unit 250 and the content management process will be described below in relation to the block diagrams shown in FIGS. 1-2.

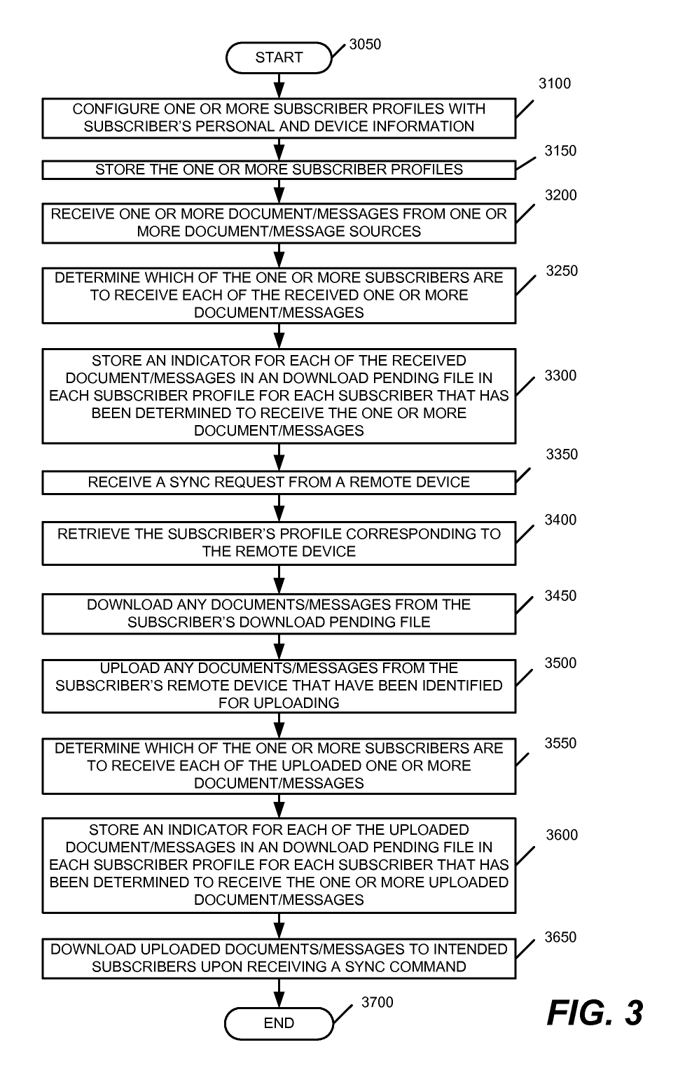

FIG. 3 is an exemplary flowchart illustrating one possible content management process in accordance with one possible embodiment of the disclosure. The process begins at step 3050 and continues to step 3100 where the content management unit 250 may configure one or more subscriber profiles with subscriber's personal and remote device information. The content management unit 250 may receiving the subscriber information from the subscriber on-line, via telephone, or via an upload from a remote device 130, for example. The received subscriber information may include the subscriber's identification information and the subscriber's remote device 130 identification information, as well as other subscriber-related and/or device-related information, for example. The subscriber's identification information may include the subscriber's job position information so that documents/messages may be downloaded to the subscriber's remote device 130 based on that subscriber's job position information, for example.

At step 3150, the content management unit 250 may store the one or more subscriber profiles with any received subscriber information in the subscriber database 295. At step 3200, the content management unit 250 may receive one or more documents/messages from one or more document/message sources. At step 3250, the content management unit 250 may determine which of the one or more subscribers are to receive each of the received one or more document/messages.

At step 3300, the content management unit 250 may store an indicator for each of the received document/messages in a download pending file in each subscriber profile for each subscriber that has been determined to receive the one or more document/messages. The indicator may be a document or file name in text, address, a document link, icon, or other known document or document location identifier. At step 3350, the content management unit 250 may receive a sync request from a remote device. Alternatively, the content management unit 250 may automatically download the documents/messages without receiving a sync request.

At step 3400, the content management unit 250 may retrieve the subscriber's profile corresponding to the remote device. At step 3450, the content management unit 250 may download any documents/messages from the subscriber's download pending file.

At step 3500, the content management unit 250 may upload any documents/messages from the subscriber's remote device 130 that have been identified for uploading. Alternatively, the remote device may automatically upload the documents/messages to the content management unit 250 when entered, on-demand, or at a predetermined time period, for example.

At step 3550, the content management unit 250 may determine which of the one or more subscribers are to receive each of the uploaded one or more document/messages. At step 3600, the content management unit 250 may store an indicator for each of the uploaded document/messages in the download pending file in each subscriber profile for each subscriber that has been determined to receive the one or more uploaded document/messages.

At step 3650, the content management unit 250 may download the uploaded documents/messages to each subscriber's device that has been determined to receive the one or more uploaded document/messages upon receiving a sync request from each subscriber. Alternatively, the content management unit 250 may automatically download the uploaded documents/messages without receiving a sync request. The process may then go to step 3700 and end.

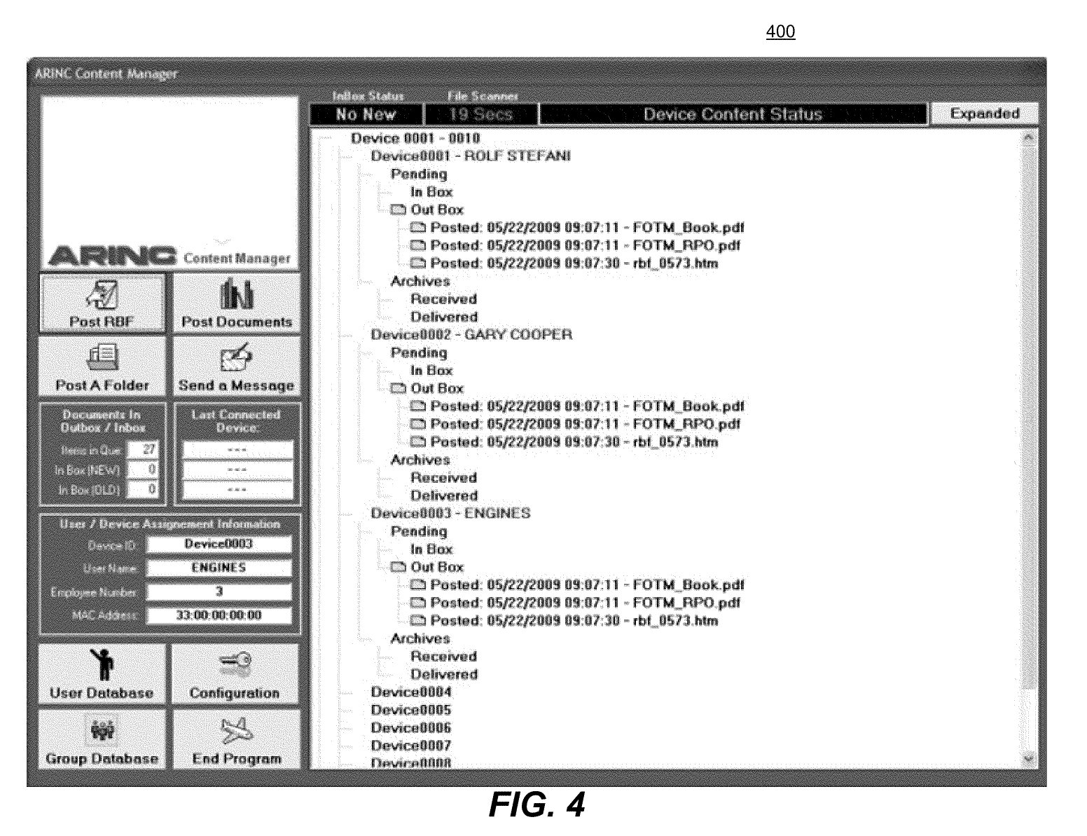

FIGS. 4-8 represent exemplary screenshots of possible processes performed by the content management system 140 and the content management process. FIG. 4 is a screenshot of an exemplary master document/message content management interface 400 in accordance with a possible embodiment of the disclosure. This interface 400 may be the content management system user's main display which provides access to all the features of the content management system 140, including but not limited to, designating devices corresponding to subscribers, assigning users to groups (e.g., job or position related), configuring items such as email addresses for users, as well as messages, documents and files that may be identified for delivery to particular remote devices 130. Note that this interface 400 may allow the user to view the near real time status of all devices configured in this system 140. The interface 400 may also show all pending transactions (upload and download) as well as an archive, for example.

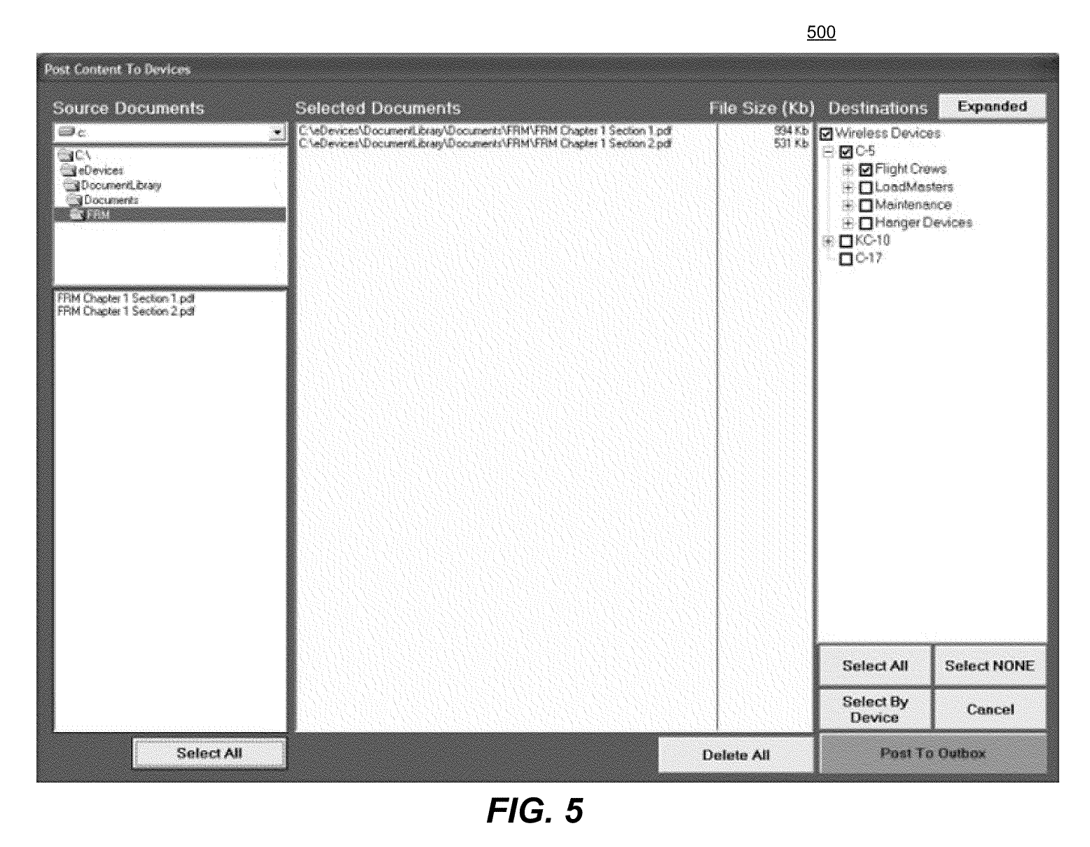

FIG. 5 is a screenshot of an exemplary list of document/message download interface 500 of content to be downloaded to one or more particular remote devices 130 in accordance with a possible embodiment of the disclosure. This interface 500 may allow the user to select a document to download to particular devices. Note that files and documents can be selected on the left side of the window and the desired subscribers are selected by either user roles or by unique device identification (selectable). The download may be immediate or when the subscriber requests to sync with the content management system 140. The center window may provide real time feedback concerning the documents/messages that have been selected for delivery to one or more particular remote devices 130. The interface 500 may also show other relevant information, such as file size and accumulated sizes of all selected documents/messages, for example.

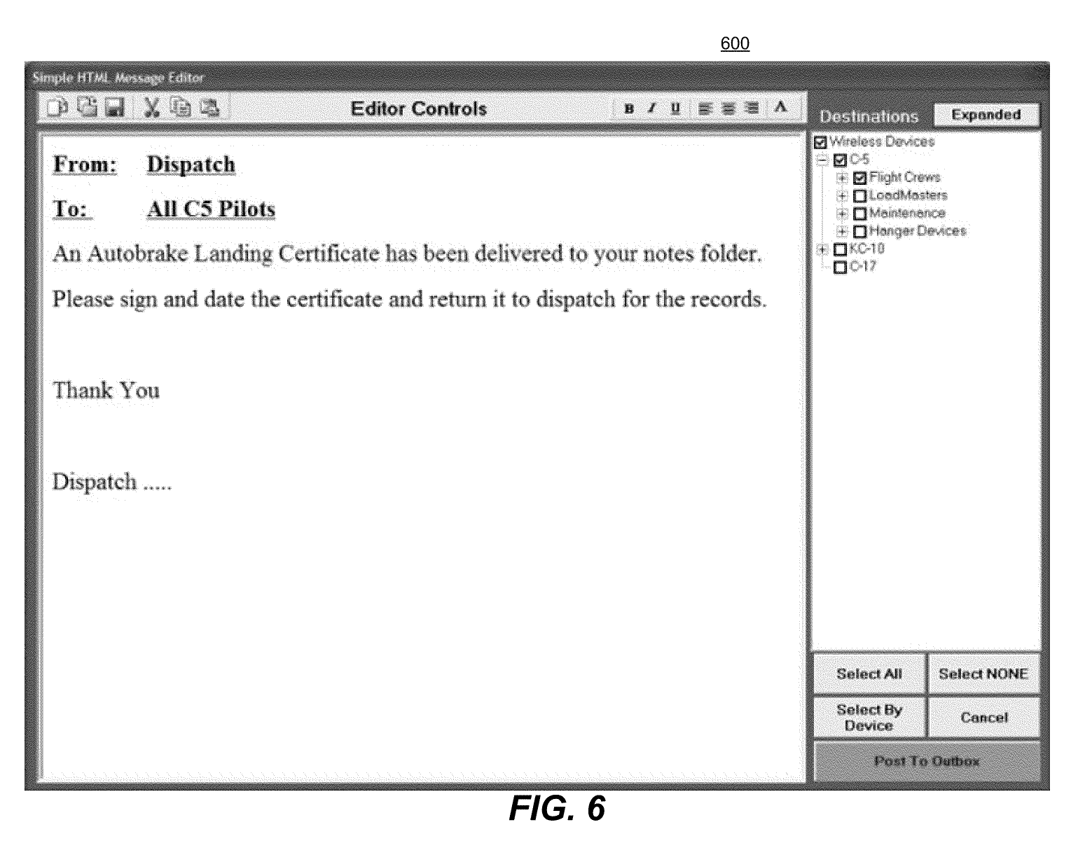

FIG. 6 is a screenshot of an exemplary message creation interface 600 in accordance with a possible embodiment of the disclosure. At this interface 600, if the user selects to send a message to a remote device 130 on the interface 400, for example, this interface 600 may be presented to allow a message to be created. Users can either compose messages dynamically or to download previously created messages to one or more remote devices 130. As in the interface 500, targeted devices/users may also be designated on the right side of the interface 600.

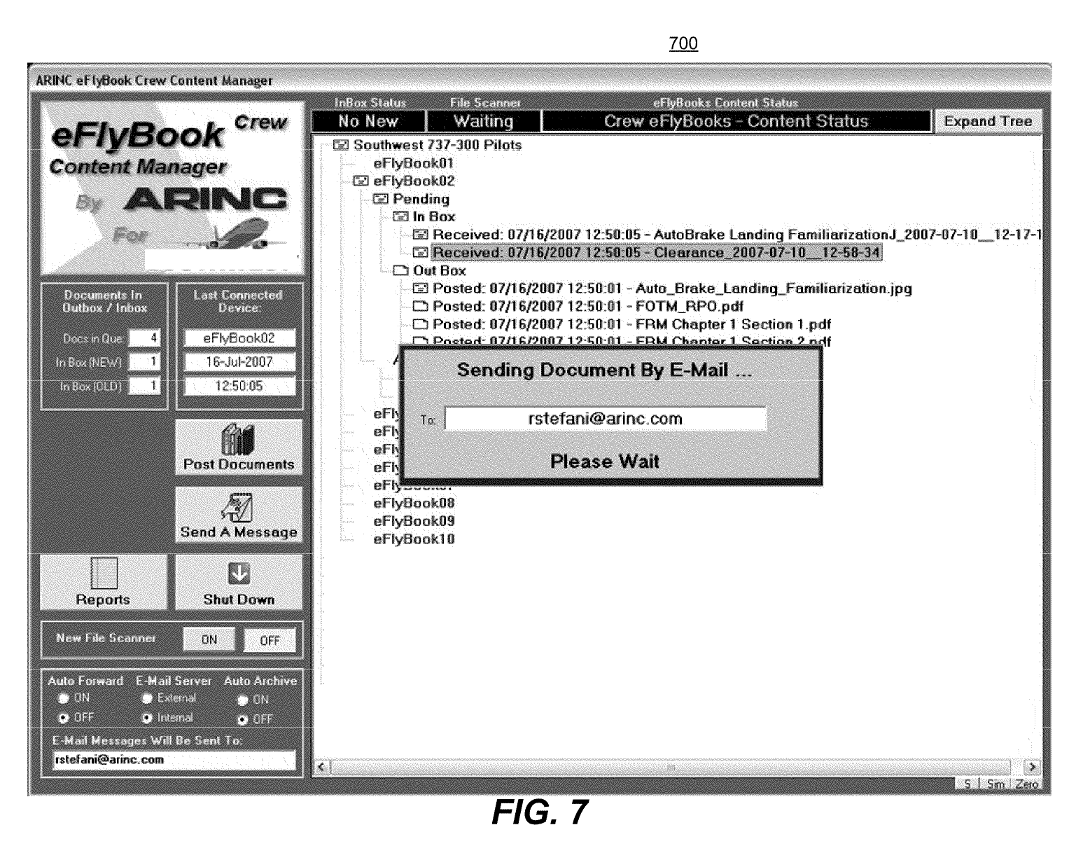

FIG. 7 is a screenshot of an exemplary interface to forward documents/messages to subscribers in accordance with a possible embodiment of the disclosure. If the content management system 140 receives a document/message from a remote device 130, the user may select this specific document for viewing, deleting, archiving or to be sent by email or upload to another subscriber. Note that the system 140 may also include the capability for rules to be applied to received documents and messages that may be executed anytime a document or message is received from a particular device or is of a particular subject matter. The system 140 can also accommodate automatic sending of received documents/messages to previously described addresses automatically.

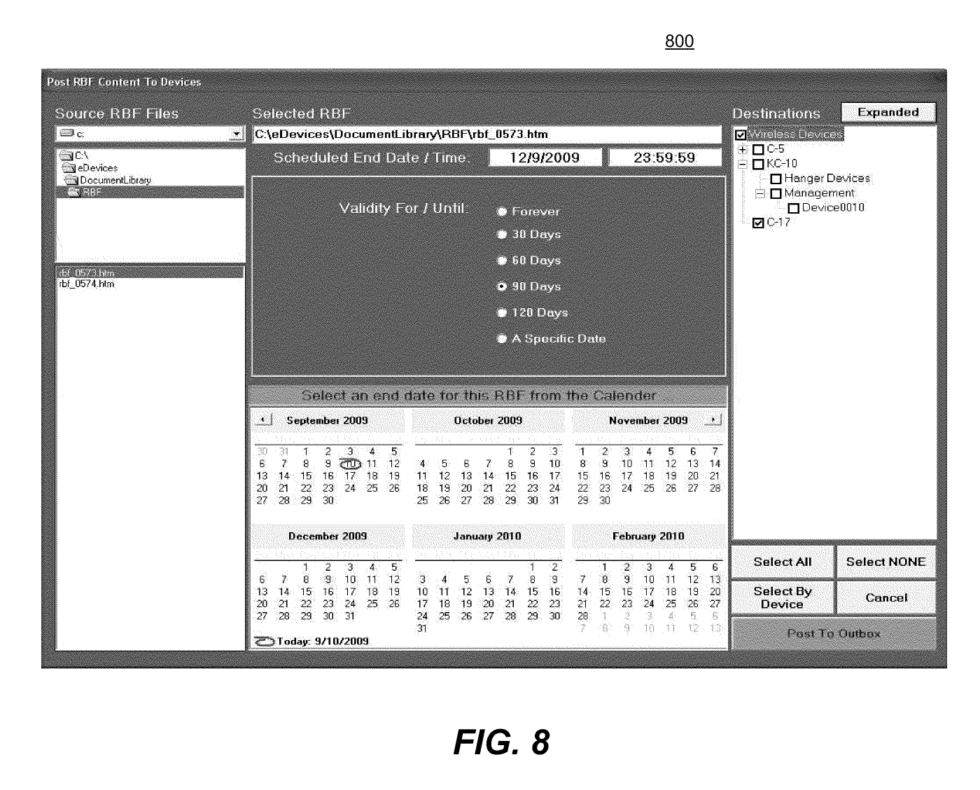

FIG. 8 is a screenshot of an exemplary interface to set the lifespan of a document 800 in accordance with a possible embodiment of the disclosure. The content management system 140 may be configured to select certain documents for delivery using discussed methods and to specify a validity period to the document. This process may allow documents to have an affectivity lifespan. In this manner, the content management system 140 may specify when a document becomes valid/viewable and when it is out-of-date and should not be used by subscribers. This interface 800 may also cause the out-of date documents to be deleted from devices at a specific time.

Embodiments within the scope of the present disclosed embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations are part of the scope of the disclosed embodiments. For example, the principles of the disclosed embodiments may be applied to each individual user where each user may individually deploy such a system. This enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A method for managing the document/message content for distribution to subscribers, comprising:
configuring one or more subscriber profiles with subscriber's personal and remote device information;
storing the one or more subscriber profiles in a subscriber database;
receiving one or more document/messages from one or more document/message sources;
determining which of the one or more subscribers are to receive each of the received one or more document/messages;
storing an indicator for each of the received document/messages in a download pending file in each subscriber profile for each subscriber that has been determined to receive the one or more document/messages;
receiving a sync request from a remote device;
retrieving the subscriber's profile corresponding to the remote device;
downloading any documents/messages from the subscriber's download pending file;
uploading any documents/messages from the subscriber's remote device that have been identified for uploading;
determining which of the one or more subscribers are to receive each of the uploaded one or more document/messages;
storing an indicator for each of the uploaded document/messages in the download pending file in each subscriber profile for each subscriber that has been determined to receive the one or more uploaded document/messages; and
downloading the uploaded documents/messages to each subscriber's device that has been determined to receive the one or more uploaded document/messages upon receiving a sync request from each subscriber.

2. The method of claim 1, further comprising:
receiving subscriber information, wherein the received subscriber information includes the subscriber's identification information and the subscriber's remote device identification information; and
storing the received subscriber information in the subscriber database.

3. The method of claim 2, wherein the subscriber's identification information includes the subscriber's job position information.

4. The method of claim 3, wherein documents/messages are downloaded to the subscriber's remote device based on the subscriber's job position information.

5. The method of claim 1, wherein the documents/messages are automatically downloaded without receiving a sync request.

6. The method of claim 1, wherein the document/message content is aviation-related.

7. The method of claim 1, wherein the method is performed by one of a server, a computer, a processing device, and a personal digital assistant.

8. A content management system, comprising:
a memory;
a subscriber database stored in the memory that contains subscriber information; and
a content management unit that configures one or more subscriber profiles with subscriber's personal and remote device information, stores the one or more subscriber profiles in the subscriber database, receives one or more document/messages from one or more document/message sources, determines which of the one or more subscribers are to receive each of the received one or more document/messages, stores an indicator for each of the received document/messages in a download pending file in each subscriber profile for each subscriber that has been determined to receive the one or more document/messages, receives a sync request from a remote device, retrieves the subscriber's profile corresponding to the remote device, downloads any documents/messages from the subscriber's download pending file, uploads any documents/messages from the subscriber's remote device that have been identified for uploading, determines which of the one or more subscribers are to receive each of the uploaded one or more document/messages, stores an indicator for each of the uploaded document/messages in the download pending file in each subscriber profile for each subscriber that has been determined to receive the one or more uploaded document/messages, and downloads the uploaded documents/messages to each subscriber's device that has been determined to receive the one or more uploaded document/messages upon receiving a sync request from each subscriber.

9. The content management system of claim 8, wherein the content management unit receives subscriber information and stores the received subscriber information in the subscriber database, wherein the received subscriber information includes the subscriber's identification information and the subscriber's remote device identification information.

10. The content management system of claim 9, wherein the subscriber's identification information includes the subscriber's job position information.

11. The content management system of claim 10, wherein the content management unit downloads documents/messages to the subscriber's remote device based on the subscriber's job position information.

12. The content management system of claim 8, wherein the content management unit automatically downloads the documents/messages without receiving a sync request.

13. The content management system of claim 8, wherein the document/message content is aviation-related.

14. The content management system of claim 8, wherein the content management system is one of a server, a computer, a processing device, and a personal digital assistant.

15. A computer-readable medium storing instructions for controlling a computing device for managing the document/message content for distribution to subscribers, the instructions comprising:
configuring one or more subscriber profiles with subscriber's personal and remote device information;
storing the one or more subscriber profiles in a subscriber database;
receiving one or more document/messages from one or more document/message sources;
determining which of the one or more subscribers are to receive each of the received one or more document/messages;
storing an indicator for each of the received document/messages in a download pending file in each subscriber profile for each subscriber that has been determined to receive the one or more document/messages;
receiving a sync request from a remote device;
retrieving the subscriber's profile corresponding to the remote device;
downloading any documents/messages from the subscriber's download pending file;
uploading any documents/messages from the subscriber's remote device that have been identified for uploading;
determining which of the one or more subscribers are to receive each of the uploaded one or more document/messages;
storing an indicator for each of the uploaded document/messages in the download pending file in each subscriber profile for each subscriber that has been determined to receive the one or more uploaded document/messages; and
downloading the uploaded documents/messages to each subscriber's device that has been determined to receive the one or more uploaded document/messages upon receiving a sync request from each subscriber.

16. The computer-readable medium of claim 15, further comprising:
receiving subscriber information, wherein the received subscriber information includes the subscriber's identification information and the subscriber's remote device identification information; and
storing the received subscriber information in the subscriber database.

17. The computer-readable medium of claim 16, wherein the subscriber's identification information includes the subscriber's job position information.

18. The computer-readable medium of claim 17, wherein documents/messages are downloaded to the subscriber's remote device based on the subscriber's job position information.

19. The computer-readable medium of claim 15, wherein the documents/messages are automatically downloaded without receiving a sync request.

20. The computer-readable medium of claim 15, wherein the document/message content is aviation-related.
